(19) United States
(12) Patent Application Publication
(10) Pub. No.: US 2025/0022136 A1
(43) Pub. Date: Jan. 16, 2025

(54) IMAGE CROPPING METHOD AND APPARATUS, MODEL TRAINING METHOD AND APPARATUS, ELECTRONIC DEVICE, AND MEDIUM

(71) Applicant: Beijing Bytedance Network Technology Co., Ltd., Shijingshan District, Beijing (CN)

(72) Inventors: Weihong Zeng, Beijing (CN); Xu Wang, Beijing (CN)

(21) Appl. No.: 18/713,602

(22) PCT Filed: Nov. 21, 2022
(86) PCT No.: PCT/CN2022/133277

§ 371 Date: May 24, 2024

(30) Foreign Application Priority Data
Nov. 24, 2021 (CN) 202111407110.6

(51) Int. Cl. G06T 7/10; G06V 10/25; G06V 10/44; G06V 10/771

(52) U.S. Cl. CPC G06T 7/10; G06V 10/25; G06V 10/44; G06V 10/771; G06T 2207/20132

(57) ABSTRACT

The present disclosure provides an image cropping method and apparatus, a model training method and apparatus, an electronic device, and a medium. The image cropping method includes: segmenting an image to be cropped to obtain a first segmented image, and determining a bounding box of a target object in the image to be cropped based on the first segmented image; generating a plurality of first candidate boxes within the bounding box, and selecting a first target box from the plurality of first candidate boxes based on an aesthetic score of a first feature map corresponding to each first candidate box; and using an image located within the first target box in the image to be cropped as a cropping result.

### CROSS-REFERENCE TO RELATED APPLICATIONS

The present application claims priority to Chinese Patent Application No. 202111407110.6, filed with the China National Intellectual Property Administration on Nov. 24, 2021, which is incorporated herein by reference in its entirety.

### TECHNICAL FIELD

The present disclosure relates to the field of image processing technologies, for example, to an image cropping method and apparatus, a model training method and apparatus, an electronic device, and a medium.

### BACKGROUND ART

In the related art, in an image cropping algorithm using aesthetic evaluation, usually, a large number of candidate boxes are generated on a global image, and image features corresponding to the candidate boxes are input into a scorer for aesthetic scoring so as to crop the image based on a candidate box with the highest score. The disadvantages in the related art include at least: the large number of candidate boxes resulting in a time-consuming scoring process, which leads to a poor real-time performance of cropping.

### SUMMARY OF THE INVENTION

The present disclosure provides an image cropping method and apparatus, a model training method and apparatus, an electronic device, and a medium, to improve the real-time performance of cropping.

According to a first aspect, the present disclosure provides an image cropping method, including:
segmenting an image to be cropped to obtain a first segmented image, and determining a bounding box of a target object in the image to be cropped based on the first segmented image;
generating a plurality of first candidate boxes within the bounding box, and selecting a first target box from the plurality of first candidate boxes based on an aesthetic score of a first feature map corresponding to each first candidate box; and
using an image located within the first target box in the image to be cropped as a cropping result.

According to a second aspect, the present disclosure further provides a model training method, including:
obtaining a first sample image, a segmentation label of the first sample image, and an aesthetic score label corresponding to a sample cropping box of the first sample image;
performing feature extraction on the first sample image to obtain a third feature map;
performing feature reconstruction on the third feature map using a segmentation model, to obtain a second segmented image, and training the segmentation model based on the second segmented image and the segmentation label;
generating a second candidate box within the first sample image, and determining a fourth feature map corresponding to the second candidate box based on the third feature map and the second candidate box; and
outputting a predicted score of the fourth feature map using an aesthetic scoring model, and training the aesthetic scoring model based on the predicted score and the aesthetic score label, where
the trained segmentation model is used for determining the first segmented image described in the image cropping method described above; and the trained aesthetic scoring model is used for determining the aesthetic score described in the image cropping method described above.

According to a third aspect, the present disclosure further provides an image cropping apparatus, including:
a bounding box determining module configured to segment an image to be cropped to obtain a first segmented image, and determine a bounding box of a target object in the image to be cropped based on the first segmented image;
a target box determining module configured to generate a plurality of first candidate boxes within the bounding box, and select a first target box from the plurality of first candidate boxes based on an aesthetic score of a first feature map corresponding to each first candidate box; and
a cropping module configured to use an image located within the first target box in the image to be cropped as a cropping result.

According to a fourth aspect, the present disclosure further provides a model training apparatus, including:
a sample obtaining module configured to obtain a first sample image, a segmentation label of the first sample image, and an aesthetic score label corresponding to a sample cropping box of the first sample image;
a feature extraction module configured to perform feature extraction on the first sample image to obtain a third feature map;
a segmentation model training module configured to perform feature reconstruction on the third feature map using a segmentation model, to obtain a second segmented image, and train the segmentation model based on the second segmented image and the segmentation label;
a candidate box feature determining module configured to generate a second candidate box within the first sample image, and determine a fourth feature map corresponding to the second candidate box based on the third feature map and the second candidate box; and
an aesthetic scoring model training module configured to output a predicted score of the fourth feature map using an aesthetic scoring model, and train the aesthetic scoring model based on the predicted score and the aesthetic score label, where
the trained segmentation model is used for determining the first segmented image described in the image cropping method described above; and the trained aesthetic scoring model is used for determining the aesthetic score described in the image cropping method described above.

According to a fifth aspect, the present disclosure further provides an electronic device, including:
one or more processors; and
a storage apparatus configured to store one or more programs, where
the one or more programs, when executed by the one or more processors, cause the one or more processors to implement the image cropping method described above, or to implement the model training method described above.

According to a sixth aspect, the present disclosure further provides a storage medium including computer-executable instructions, where the computer-executable instructions, when executed by a computer processor, are used to perform the image cropping method described above, or to implement the model training method described above.

### BRIEF DESCRIPTION OF DRAWINGS

FIG. 1 is a schematic flowchart of an image cropping method according to Embodiment 1 of the present disclosure;

FIG. 2 is a flow block diagram of the image cropping method according to Embodiment 1 of the present disclosure;

FIG. 3 is a flow block diagram of an image cropping method according to Embodiment 2 of the present disclosure;

FIG. 4 is an example diagram of cropping results corresponding to different crop ratios in an image cropping method according to Embodiment 3 of the present disclosure;

FIG. 5 is a flow block diagram of the image cropping method according to Embodiment 3 of the present disclosure;

FIG. 6 is a schematic flowchart of a model training method according to Embodiment 4 of the present disclosure;

FIG. 7 is a flow block diagram of the model training method according to Embodiment 4 of the present disclosure;

FIG. 8 is a schematic diagram of a structure of an image cropping apparatus according to Embodiment 5 of the present disclosure;

FIG. 9 is a schematic diagram of a structure of a model training apparatus according to Embodiment 6 of the present disclosure; and

FIG. 10 is a schematic diagram of a structure of an electronic device according to Embodiment 7 of the present disclosure.

### DETAILED DESCRIPTION OF THE INVENTION

Embodiments of the present disclosure are described below with reference to the accompanying drawings. Although some embodiments of the present disclosure are shown in the accompanying drawings, the present disclosure may be implemented in various forms, and these embodiments are provided for understanding the present disclosure. The accompanying drawings and the embodiments of the present disclosure are for exemplary purposes only.

Various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

The concepts such as “first” and “second” mentioned in the present disclosure are only used to distinguish different apparatuses, modules, or units, and are not used to limit the sequence of functions performed by these apparatuses, modules, or units or interdependence.

The modifiers “one” and “a plurality of” mentioned in the present disclosure are illustrative and not restrictive, and those skilled in the art should understand that unless the context indicates otherwise, the modifiers should be understood as “one or more”.

### Embodiment 1

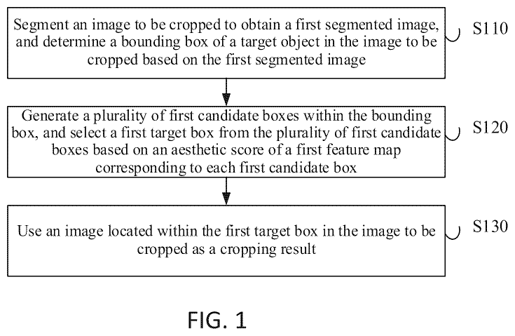

FIG. 1 is a schematic flowchart of an image cropping method according to Embodiment 1 of the present disclosure. This embodiment of the present disclosure is applicable to image cropping, for example, to cropping of an image containing a salient object. The method may be performed by an image cropping apparatus. The apparatus may be implemented in the form of software and/or hardware, and may be configured in an electronic device, for example, in a mobile phone or a computer.

As shown in FIG. 1, the image cropping method provided in this embodiment may include the following steps.

S110: Segment an image to be cropped to obtain a first segmented image, and determine a bounding box of a target object in the image to be cropped based on the first segmented image.

In this embodiment of the present disclosure, the image to be cropped may be a currently collected image or a target image read from preset storage space, and the image to be cropped may be an image of any resolution. The first segmented image may be considered as an image obtained through semantic segmentation performed on the image to be cropped. The semantic segmentation may refer to the implementation of pixel-by-pixel classification prediction with semantics as a classification standard, and each semantic class may represent different individual objects or the same class of objects. In the first segmented image, pixels belonging to different semantic classes may be distinguished by different formats, for example, by different colors and different grayscale values.

Semantic segmentation may be performed on the image to be cropped based on an image semantic segmentation algorithm to obtain the first segmented image. The image semantic segmentation algorithm may include, but is not limited to, a conventional semantic segmentation algorithm implemented based on random forest classifiers and a network model segmentation algorithm implemented based on deep learning.

The obtained first segmented image may be presented, and a user may be prompted to select a desired semantic class for cropping. Further, an object of the semantic class selected by the user may be determined as the target object; and/or a saliency analysis may be performed on the obtained first segmented image, and an object of a semantic class with saliency is determined as the target object. The saliency analysis may be performed on the first segmented image based on a proportion of pixels belonging to the same semantic class in all pixels; or the saliency analysis may be performed on the first segmented image based on a proportion of an area of a connected region formed by pixels belonging to the same semantic class in an area of the first segmented image.

Generally, the image to be cropped has the same resolution as the first segmented image, and when the first segmented image has a high precision, an image region representing the same object is the same in the image to be cropped and in the corresponding first segmented image. Therefore, a bounding box of a target object in the first segmented image may be determined based on a set of pixels in a format corresponding to the target object in the first segmented image, and then the bounding box may be used as the bounding box of the target object in the object to be cropped.

The bounding box may be a closed box containing the whole target object with a distance from a contour of the target object greater than a first preset value and less than a second preset value. In addition, the bounding box may be, for example, a rectangular box, or an irregular polygonal box adaptively generated based on a shape of the target object. For example, the bounding box may be a rectangular box, thereby facilitating the generation of a candidate box with a specific crop ratio within the bounding box.

S120: Generate a plurality of first candidate boxes within the bounding box, and select a first target box from the plurality of first candidate boxes based on an aesthetic score of a first feature map corresponding to each first candidate box.

In this embodiment of the present disclosure, the first candidate boxes may be represented as candidate cropping ranges determined for completing image cropping, and the first target box may be represented as a final cropping range determined for completing image cropping. The plurality of first candidate boxes may be generated in a sliding window manner within the bounding box in the image to be cropped, and feature extraction is performed on the image in each first candidate box to obtain a corresponding first feature map. Each first feature map may be input into a pre-trained aesthetic scoring model such that the aesthetic scoring model outputs the aesthetic score of the first feature map.

The first candidate box corresponding to the highest aesthetic score may be determined as the first target box. Alternatively, first candidate boxes corresponding to the top N high aesthetic scores may be presented, and the user may be prompted to select a desired cropping range. Further, the first candidate box corresponding to the cropping range selected by the user may be determined as the first target box, where N may be an integer greater than or equal to 1.

Compared with the conventional image cropping solution where candidate boxes are generated in a global image, the number of the candidate boxes can be greatly reduced in this embodiment by first determining the bounding box of the target object and then generating the plurality of candidate boxes within the bounding box. It has been verified by experiments that the number of the candidate boxes can be reduced by 10 to 20 times. This embodiment not only reduces the extraction time and storage space of the corresponding features of the candidate boxes, but also reduces the time for performing aesthetic scoring by the aesthetic scoring model, such that the real-time performance of image cropping can be improved. Furthermore, the preference of the aesthetic scoring model for a salient object in the image to be cropped may be enhanced when the bounding box is determined based on the salient object. In addition, generating the candidate boxes within the bounding box can avoid cropping an object in a wrong position.

S130: Use an image located within the first target box in the image to be cropped as a cropping result.

After the first target box is determined, the image to be cropped may be cropped based on the first target box, and the image located within the first target box in the image to be cropped may be retained as the cropping result.

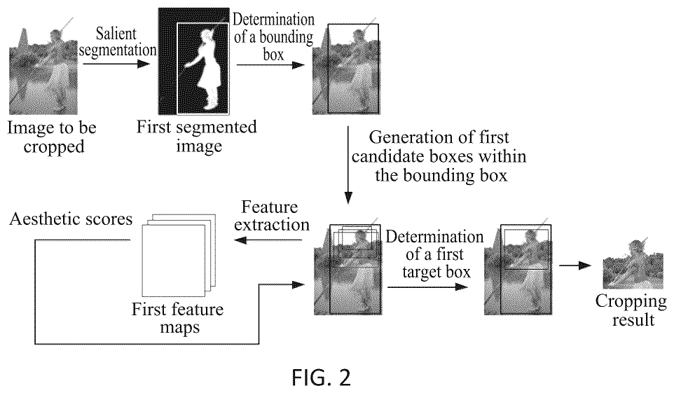

For example, FIG. 2 is a flow block diagram of the image cropping method according to Embodiment 1 of the present disclosure. Refer to FIG. 2. First, salient segmentation may be performed on the image to be cropped to obtain the first segmented image. Second, the bounding box of the target object in the first segmented image may be determined, and may be further used as the bounding box of the target object in the image to be cropped. Then, the plurality of first candidate boxes may be generated within the bounding box in the image to be cropped, and feature extraction may be performed on the image in each first candidate box to obtain a plurality of first feature maps. Next, the aesthetic score of each first feature map may be determined and the first target box may be determined from the first candidate boxes based on the plurality of aesthetic scores. Finally, the image located within the first target box in the image to be cropped is used as the cropping result.

This embodiment is applicable to situations where high real-time performance is required and/or resources are limited, for example, to a situation where image cropping is performed on a mobile terminal with limited computing/storage resources. Determining the bounding box of the target object based on the segmented image can greatly reduce the cropping range, such that the number of the generated candidate boxes can be reduced, which can reduce an amount of computation and save storage and improve the real-time performance of cropping on the mobile terminal. Furthermore, determining the final target box based on the aesthetic scores can impart a sense of beauty to the cropping result and ensure the cropping effect.

According to the technical solution of this embodiment of the present disclosure, the image to be cropped is segmented to obtain the first segmented image, and the bounding box of the target object in the image to be cropped is determined based on the first segmented image. The plurality of first candidate boxes are generated within the bounding box, and the first target box is selected from the plurality of first candidate boxes based on the aesthetic score of the first feature map corresponding to each first candidate box. The image located within the first target box in the image to be cropped is used as the cropping result. Determining the bounding box of the target object in the image to be segmented based on the segmented image and generating the first candidate boxes within the bounding box can reduce the cropping range, and can greatly reduce the number of the generated candidate boxes, such that the time for the scoring process can be reduced and the real-time performance of cropping can be improved.

### Embodiment 2

This embodiment of the present disclosure may be combined with the solution in the image cropping method provided in the above embodiment. In an image cropping method provided in this embodiment, steps of determining a first segmented image, determining a bounding box, and generating a first candidate box are described.

The first segmented image can be obtained through feature reconstruction performed using a segmentation model. Since an image to be cropped has the same resolution as the first segmented image, a bounding box of a target object in the image to be cropped can be determined based on position coordinates of a set of pixels in the format corresponding to the target object in the first segmented image. Furthermore, the first candidate boxes may be generated based on a crop ratio input by the user, and/or a corresponding number of first candidate boxes may be generated based on a cropping precision input by the user, thereby enabling flexible generation of the candidate boxes.

In some implementations, segmenting the image to be cropped to obtain the first segmented image may include: performing feature extraction on the image to be cropped to obtain a second feature map, and performing feature reconstruction on the second feature map using a segmentation model, to obtain the first segmented image. Accordingly, a first feature map is determined based on the second feature map and the first candidate boxes.

The image to be cropped may be down-sampled at a plurality of levels to extract feature maps at different levels, and the feature maps at different levels may all be second feature maps. The feature map at a higher level has a lower resolution, and may have more semantic information, but lack spatial information. The feature map at a lower level has a higher resolution, and may have more fine spatial information, but lack semantic information. The spatial information may represent spatial position relationships or direction relationships between a plurality of objects in the image, and the semantic information may represent semantic attributes of the objects contained in the image.

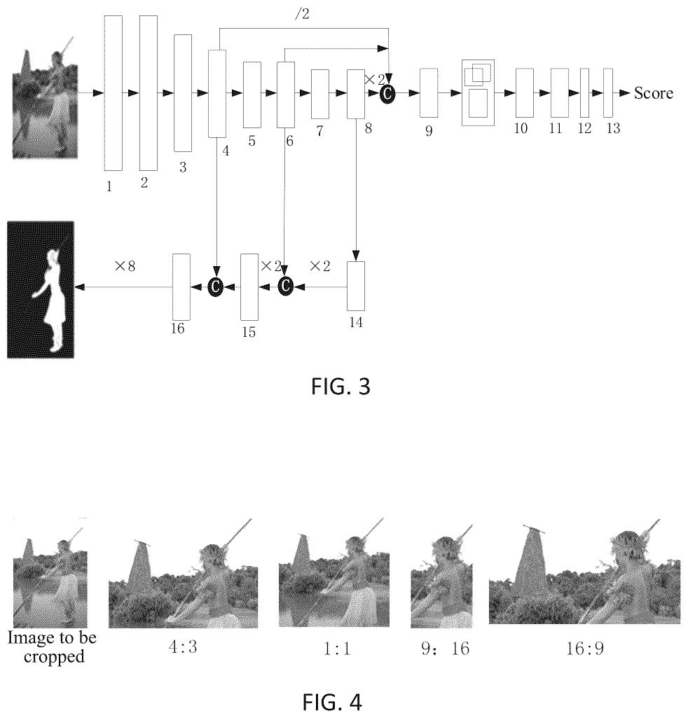

For example, FIG. 3 is a flow block diagram of the image cropping method according to Embodiment 2 of the present disclosure. Referring to FIG. 3, the image to be cropped may be down-sampled at a plurality of levels through network layers 1 to 8 to extract feature maps at different levels. The network layer 1 may be a network layer including a convolutional layer (Conv), a batch normalization layer (BN), and a rectified linear unit (ReLU). The network layers 2 to 8 may all be inverted residual layers provided in MobileNetV2.

The resolution of the feature map output through the network layer 3 may be ½ of the resolution of the image to be cropped, the resolution of the feature map output through the network layer 4 may be ¼ of the resolution of the image to be cropped, the resolution of the feature map output through the network layer 6 may be ⅛ of the resolution of the image to be cropped, and the resolution of the feature map output through the network layer 8 may be 1/16 of the resolution of the image to be cropped. It can be considered that the feature map output through the network layer 3 is a feature map at a lower level, and the feature map output through the network layer 8 is a feature map at a higher level.

Refer again to FIG. 3. The feature map output through the network layer 8 may be subjected to feature reconstruction through network layers 14 to 16 to restore the feature map at the higher level to the original resolution and implement pixel-by-pixel classification of semantic attributes, to obtain the first segmented image. The segmentation model may be composed of the network layers 14 to 16, any one of the network layers 14 to 16 may be composed of Conv, BN, and ReLU, and the segmentation model may use a U-net structure.

In FIG. 3, in the process of restoring the feature map at the higher level to the original resolution, the feature map at the current level may be first up-sampled and then skip-connected to a feature map with the same resolution in the process of down-sampling so as to add the spatial information on the basis of the semantic information to achieve feature fusion. For example, the feature map output through the network layer 14 in FIG. 3 may be first double up-sampled (indicated by “×2” in the figure) and then fused (indicated by a circled letter C in the figure) with the feature map output through the network layer 6.

The feature map output through the network layer 8 may be first double up-sampled, and then spliced (also indicated by a circled letter C in the figure) with the feature map output through the network layer 6 and the feature map obtained by double down-sampling (indicated by “/2” in the figure) the feature map output through the network layer 4, and the spliced image is subjected to convolution processing through the network layer 9 (for example, which is a Conv layer) to obtain a final feature map. The final feature map is also a second feature map.

After the first segmented image is determined, the bounding box of the target object in the image to be cropped may be determined, so that the plurality of first candidate boxes can be generated within the bounding box of the image to be cropped. In this case, the features within the ranges corresponding to the first candidate boxes in the final feature map may be determined as the first feature maps corresponding to the first candidate boxes. Since there is a correspondence between the image to be cropped and the final feature map in terms of resolution compression multiples, the ranges of the final feature map to which the first candidate boxes are mapped may be determined based on the correspondence, such that the features within the ranges to which the first candidate boxes are mapped may form the first feature maps corresponding to the first candidate boxes.

In these implementations, the first segmented image may be generated using the segmentation model, and the segmentation model may be, for example, a salient segmentation branch network. Furthermore, the aesthetic scoring model may be composed of the network layers 10 to 13, and any one of the network layers 10 and 11 may be composed of Conv, BN, and ReLU, and the network layers 12 and 13 may be fully connected layers. After the first feature maps are obtained, the first feature maps may be passed through the network layers 10 to 13 to determine the aesthetic scores (score in the figure) of the first feature maps. In addition, the first target box may be selected from the plurality of first candidate boxes based on the aesthetic scores, and the image located within the first target box in the image to be cropped may be used as the cropping result.

In some implementations, determining the bounding box of the target object in the image to be cropped based on the first segmented image may include: determining the bounding box of the target object in the image to be cropped based on position coordinates of pixels in the first segmented image that belong to a semantic class of the target object.

Since the bounding box of the same object may have the same position coordinates in the first segmented image and in the image to be cropped, it is only required to determine the bounding box based on the first segmented image. Refer to FIG. 3. The bounding box may be a rectangular box, and the rectangular box may be represented by position coordinates of an upper left corner and a lower right corner, or an upper right corner and a lower left corner of the rectangular box.

The process of determining the bounding box of the target object in the first segmented image is as follows. First, the position coordinates of the plurality of pixels in the first segmented image that belong to the semantic class of the target object may be determined. Next, uppermost/lowermost/leftmost/rightmost pole pixels may be determined, and an initial rectangular box surrounding the target object may be determined based on position coordinates of the pole pixels. Finally, the bounding box of the target object may be obtained by extending a certain area outward on the basis of the initial rectangular box. The position coordinates may be pixel coordinates.

In these implementations, the initial rectangular box may be determined based on the position coordinates of the pixels of the target object, and the bounding box may be obtained through extending on the basis of the initial rectangular box, such that the target object occupies an appropriate area and position in the cropping result, thereby ensuring the cropping effect.

In some implementations, generating the plurality of first candidate boxes within the bounding box may include: generating, based on an input crop ratio, first candidate boxes conforming to the crop ratio within the bounding box; and/or generating, based on an input cropping precision, a number of first candidate boxes corresponding to the cropping precision within the bounding box.

The crop ratio may be any image aspect ratio input by the user, for example, 4:3, 3:4, 1:1, 9:16, or 16:9. Windows with different sizes but the same crop ratio may be used to slide within the bounding box to generate a plurality of first candidate boxes with different sizes but the same crop ratio. For example, FIG. 4 is an example diagram of cropping results corresponding to different crop ratios in an image cropping method according to Embodiment 3 of the present disclosure. Refer to FIG. 4, the image to be cropped may be cropped into an image with an aspect ratio, for example, 4:3, 1:1, 9:16, or 16:9, based on the image cropping method according to this embodiment of the present disclosure.

The cropping precision may be a predefined precision level, e.g., classified as low, medium, and high levels. The numbers of first candidate boxes corresponding to cropping precisions from low to high may be increased, and the numbers of first candidate boxes corresponding to different cropping precisions may be preset. Accordingly, a corresponding number may be determined based on the desired cropping precision input by the user, and the number of first candidate boxes are generated within the bounding box.

The first candidate boxes may be determined based on the crop ratio and/or the cropping precision input by the user. When the user inputs only the crop ratio, the cropping precision may be set to a default value, e.g., to the medium precision level. When the user inputs only the cropping precision, the crop ratio may be set to a default value, an optimal value, all ratios that are available for output, etc. The default value may be any one of all ratios, such as 1:1. The optimal value may be the one closest to the ratio of the original image to be cropped among all ratios. Generating the first candidate boxes based on the optimal value of the crop ratio can avoid cropping of an excessive area, and ensure the resolution of the cropping result. Generating the first candidate boxes based on all ratios that are available for output can provide richer cropping results for users to meet their needs.

In these implementations, the first candidate boxes may be generated based on the crop ratio input by the user, and/or the corresponding number of first candidate boxes may be generated based on the cropping precision input by the user, thereby enabling flexible generation of the candidate boxes.

In the technical solution of this embodiment of the present disclosure, steps of determining the first segmented image, determining the bounding box, and generating the first candidate boxes are described. The first segmented image can be obtained through feature reconstruction performed using the segmentation model. Since the image to be cropped has the same resolution as the first segmented image, the bounding box of the target object in the image to be cropped can be determined based on position coordinates of the set of pixels in the format corresponding to the target object in the first segmented image. Furthermore, the first candidate boxes may be generated based on the crop ratio input by the user, and/or the corresponding number of first candidate boxes may be generated based on the cropping precision input by the user, thereby enabling flexible generation of the candidate boxes.

The image cropping method provided in this embodiment of the present disclosure and the image cropping method provided in the above embodiment belong to the same concept. For the technical details not described in detail in this embodiment, reference can be made to the above embodiment, and the same technical features have the same effects in this embodiment and the above embodiment.

### Embodiment 3

This embodiment of the present disclosure may be combined with the solutions in the image cropping methods provided in the above embodiments. In an image cropping method provided in this embodiment, a step of determining an aesthetic score of a first feature map is described.

Since the number of first candidate boxes may vary depending on the cropping precision input by the user, the number of corresponding first feature maps may vary with the cropping precision. However, an aesthetic scoring model can only process a fixed number of first feature maps. If the generated first feature maps are directly input into the aesthetic scoring model, it is likely to cause an abnormal scoring, i.e., the first feature maps beyond the fixed number cannot be scored.

In some implementations, after a plurality of first candidate boxes are generated, the method further includes: inputting, based on a single throughput of the aesthetic scoring model, the plurality of first feature maps respectively corresponding to the plurality of first candidate boxes into the aesthetic scoring model in batches, such that the aesthetic scoring model outputs the aesthetic score of each first feature map.

In these implementations, the single throughput of the aesthetic scoring model, which is usually set to a fixed value, may be considered as the number of channels of the first feature maps that can be processed in one go. When the number of first feature maps corresponding to the first candidate boxes is variable, the generated first feature maps may be input into the aesthetic scoring model in batches for aesthetic scoring in batches by using the aesthetic scoring model.

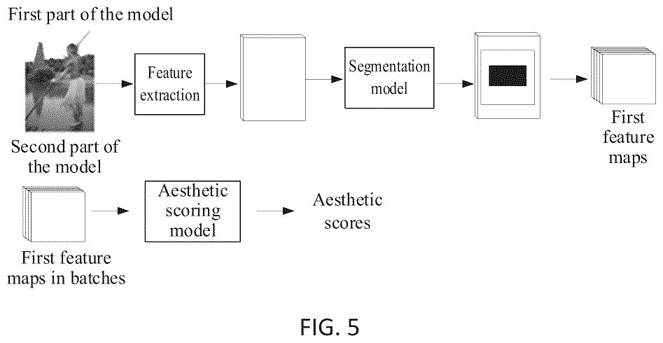

For example, FIG. 5 is a flow block diagram of the image cropping method according to Embodiment 3 of the present disclosure. Refer to FIG. 5. In this embodiment, image cropping is implemented based on a two-part model, where a first part of the model may include the segmentation model which may be used for generating the plurality of first feature maps based on the image to be cropped; and a second part of the model may include the aesthetic scoring model which may be used for receiving the plurality of first feature maps in batches for aesthetic scoring on first feature maps in each batch. Therefore, aesthetic scoring may be performed on each first feature map successfully as the number of first feature maps changes.

Furthermore, when the number of first feature maps corresponding to the first candidate boxes is fixed, the single throughput of the aesthetic evaluation model may be set to the fixed value. In this case, instead of splitting the model into two parts, the first feature maps output by the segmentation model may be directly input into the aesthetic scoring model to complete the aesthetic scoring in one go.

In some implementations, before the plurality of first feature maps respectively corresponding to the plurality of first candidate boxes are input into the aesthetic scoring model in batches, the method further includes: resizing the first feature maps corresponding to the first candidate boxes to a preset size.

In these implementations, since the first candidate boxes may differ in size while having the same ratio, all of the first feature maps may be resized to the unified preset size before the first feature maps are input into the aesthetic scoring model, which facilitates aesthetic scoring with a unified standard.

The resizing may be performed based on a “resize” operation of Open-CV, or the resizing and other more complex operations may be performed based on a region of interest (ROI) “align” operation of the C language. Furthermore, other pre-processing operations may be applied to the first feature maps, which are not exhausted herein. The preset size may be set based on an actual scene. For example, when the crop ratio is 1:1, the preset size may be set to 9×9.

In the technical solution of this embodiment of the present disclosure, a step of determining an aesthetic score of a first feature map is described. Image cropping is implemented based on the two-part model, where the first part of the model may include the segmentation model which may be used for generating the plurality of first feature maps based on the image to be cropped; and the second part of the model may include the aesthetic scoring model which may be used for receiving the plurality of first feature maps in batches for aesthetic scoring on first feature maps in each batch. Therefore, aesthetic scoring may be performed on each first feature map successfully as the number of first feature maps changes.

Furthermore, the image cropping method provided in this embodiment of the present disclosure and the image cropping method provided in the above embodiment belong to the same concept. For the technical details not described in detail in this embodiment, reference can be made to the above embodiment, and the same technical features have the same effects in this embodiment and the above embodiment.

### Embodiment 4

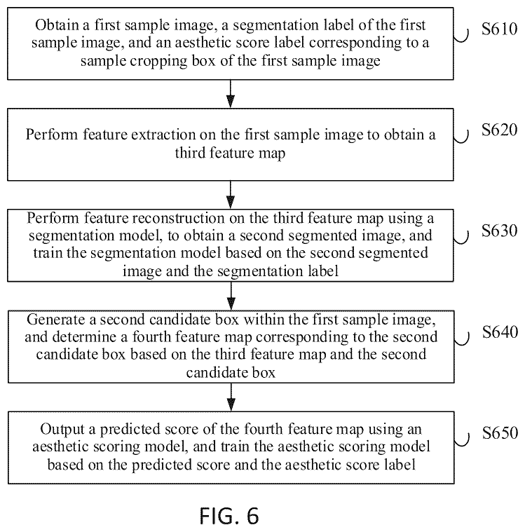

FIG. 6 is a schematic flowchart of a model training method according to Embodiment 4 of the present disclosure. This embodiment of the present disclosure is applicable to training an image cropping model including a segmentation model and an aesthetic scoring model. The method may be performed by a model training apparatus. The apparatus may be implemented in the form of software and/or hardware, and may be configured in an electronic device, for example, in a computer.

As shown in FIG. 6, the model training method provided in this embodiment may include the following steps.

S610: Obtain a first sample image, a segmentation label of the first sample image, and an aesthetic score label corresponding to a sample cropping box of the first sample image.

In this embodiment of the present disclosure, the first sample image may be an image obtained from an open source database, a collected image, an image obtained after virtual rendering, etc. The segmentation label of the first sample image may be considered as a segmented image of the first sample image. A plurality of sample cropping boxes may be labeled in the first sample image, and each sample cropping box may be labeled with an aesthetic score label.

S620: Perform feature extraction on the first sample image to obtain a third feature map.

For the step of performing feature extraction on the first sample image, reference can be made to the step of performing feature extraction on the image to be cropped. A feature map at each level corresponding to the first sample image may be referred to as a third feature map.

S630: Perform feature reconstruction on the third feature map using a segmentation model, to obtain a second segmented image, and train the segmentation model based on the second segmented image and the segmentation label.

For the step of reconstructing the second segmented image from the third feature map using the segmentation model, reference can be made to the step of reconstructing the first segmented image from the second feature map using the segmentation model.

The segmentation model may be trained based on a first loss value between the second segmented image output by the segmentation model and the segmentation label. The first loss value may be calculated based on a first loss function, and the first loss function may be, for example, a cross entropy loss (CE Loss) function.

S640: Generate a second candidate box within the first sample image, and determine a fourth feature map corresponding to the second candidate box based on the third feature map and the second candidate box.

For the step of generating the second candidate box within the first sample image, reference can be made to the step of generating the first candidate boxes within the bounding box. For the step of determining the fourth feature map corresponding to the second candidate box based on the third feature map and the second candidate box, reference may be made to the step of determining the first feature maps corresponding to the first candidate boxes based on the second feature map and the first candidate boxes.

S650: Output a predicted score of the fourth feature map using an aesthetic scoring model, and train the aesthetic scoring model based on the predicted score and the aesthetic score label.

In the training process of the aesthetic scoring model, the aesthetic scores corresponding to candidate boxes with different positions and sizes may be regressed based on the predicted scores of the fourth feature maps corresponding to the second candidate boxes output by the aesthetic scoring model. Further, the aesthetic evaluation model may be trained based on a second loss value between a regression score corresponding to each sample cropping box in a regression result and an aesthetic score label corresponding to the sample cropping box. The second loss value may be calculated based on a second loss function, and the second loss function may be, for example, a pixel-wise smooth mean absolute error loss (Smooth L1 Loss) function.

The first loss function and the second loss function as mentioned above are merely exemplary, and other commonly used loss functions can also be applied thereto. The segmentation model and the aesthetic scoring model included in an integrated network may be trained simultaneously based on a loss value sum of the first loss value and the second loss value. Alternatively, the segmentation model may be trained based on the first loss value and the aesthetic scoring model may be trained based on the second loss value. If the two models are trained simultaneously, training of the two models may be considered as being completed when the loss value sum is less than a first threshold. If the two models are trained separately, training of the segmentation model may be considered as being completed when the first loss value is less than a second threshold, and training of the aesthetic scoring model may be considered as being completed when the second loss value is less than a third threshold.

The trained segmentation model may be used for determining the first segmented image in any of the image cropping methods of the embodiments of the present disclosure. The trained aesthetic scoring model is used for determining the aesthetic score in any of the image cropping methods of the embodiments of the present disclosure.

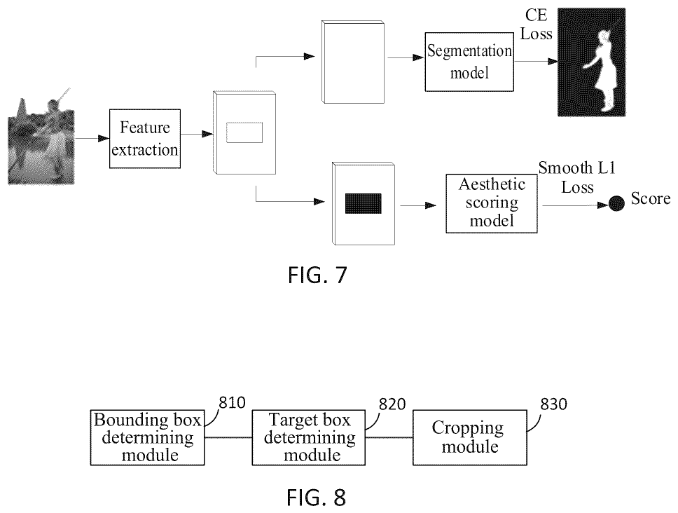

For example, FIG. 7 is a flow block diagram of the model training method according to Embodiment 4 of the present disclosure. Refer to FIG. 7. Feature extraction may be performed on the first sample image to obtain the third feature map. The third feature map is input into the segmentation model, and the fourth feature map determined based on the third feature map and the second candidate boxes is input into the aesthetic scoring model. The first loss value (e.g., CE Loss in the figure) is determined between the second segmented image output by the segmentation model and the segmentation label, and the second loss value (e.g., Smooth L1 Loss in the figure) is determined between the predicted score output by the aesthetic scoring model and the aesthetic score label. The network including the segmentation model and the aesthetic scoring model is trained based on the sum of the first loss value and the second loss value.

In some implementations, if the first sample image and the aesthetic score label belong to an aesthetic evaluation data set, the segmentation label is obtained by segmenting the first sample image based on a preset model. In general, commonly used aesthetic evaluation data sets, such as a grid anchor based image cropping data set (GAICD), do not contain a segmentation label of the first sample image. In order to obtain the segmentation label of the first sample image in the aesthetic evaluation data set, the first sample image may be segmented based on a mature preset model, such as a boundary-aware salient object detection network (BAS-Net) model, such that the segmentation model can be trained based on the segmentation label.

Accordingly, when the segmentation model and the aesthetic scoring model are trained, the method may further include: obtaining a second sample image, and labeling the second sample image with a segmentation label; and fixing parameters of the aesthetic scoring model, determining a third segmented image of the second sample image using the trained segmentation model, and optimizing the segmentation model based on the third segmented image and the segmentation label of the second sample image.

Due to less sample data in the aesthetic evaluation data set, the segmentation model is less trained. After the initial training of the segmentation model and the aesthetic scoring model is completed based on the aesthetic evaluation data set, the segmentation model may be optimized and trained based on an expanded sample set (i.e., the second sample image and the segmentation label labeled thereon) with the parameters of other parts being fixed in the network so as to obtain a better image segmentation effect, facilitating an accurate generation of the bounding box. For the step of training the segmentation model based on the segmentation label of the second sample image, reference can be made to the step of training the segmentation model based on the segmentation label of the first sample image.

In these implementations, when the segmentation model and the aesthetic scoring model are trained by using the aesthetic evaluation data set as a training set, a training set of the segmentation model may be expanded after the training is completed so as to optimize and train the segmentation model individually, thereby improving the segmentation precision of the segmentation model.

According to the technical solution of this embodiment of the present disclosure, the first sample image, the segmentation label of the first sample image, and the aesthetic score label corresponding to the sample cropping box of the first sample image are obtained. Feature extraction is performed on the first sample image to obtain the third feature map. Feature reconstruction is performed on the third feature map using the segmentation model, to obtain the second segmented image, and the segmentation model is trained based on the second segmented image and the segmentation label. The second candidate box is generated within the first sample image, and the fourth feature map corresponding to the second candidate box is determined based on the third feature map and the second candidate box. The predicted score of the fourth feature map is output using the aesthetic scoring model, and the aesthetic scoring model is trained based on the predicted score and the aesthetic score label.

The image cropping model including the segmentation model and the aesthetic scoring model is trained, such that the first segmented image in any of the image cropping methods of the embodiments of the present disclosure can be determined using the trained segmentation model. Further, determining the bounding box of the target object in the image to be cropped based on the first segmented image and generating the first candidate boxes within the bounding box can reduce the cropping range, and greatly reduce the number of the generated candidate boxes. Finally, the first feature map corresponding to each first candidate box may be subjected to aesthetic scoring by using the trained aesthetic scoring model so as to achieve image cropping based on the aesthetic score.

### Embodiment 5

FIG. 8 is a schematic diagram of a structure of an image cropping apparatus according to Embodiment 5 of the present disclosure. The image cropping apparatus provided in this embodiment is applicable to image cropping, and in particular, to cropping of an image containing a salient object.

As shown in FIG. 8, the image cropping apparatus provided in this embodiment may include:
a bounding box determining module 810 configured to segment an image to be cropped to obtain a first segmented image, and determine a bounding box of a target object in the image to be cropped based on the first segmented image; a target box determining module 820 configured to generate a plurality of first candidate boxes within the bounding box, and select a first target box from the plurality of first candidate boxes based on an aesthetic score of a first feature map corresponding to each first candidate box; and a cropping module 830 configured to use an image located within the first target box in the image to be cropped as a cropping result.

In some implementations, the bounding box determining module may include:
a segmenting unit configured to perform feature extraction on the image to be cropped to obtain a second feature map, and perform feature reconstruction on the second feature map using a segmentation model, to obtain the first segmented image. Accordingly, the first feature map is determined based on the second feature map and the first candidate boxes.

In some implementations, the bounding box determining module may include:
a bounding box determining unit configured to determine the bounding box of the target object in the image to be cropped based on position coordinates of pixels in the first segmented image that belong to a semantic class of the target object.

In some implementations, the target box determining module may include:
a candidate box generating unit configured to generate, based on an input crop ratio, first candidate boxes conforming to the crop ratio within the bounding box; and/or generate, based on an input cropping precision, a number of first candidate boxes corresponding to the cropping precision within the bounding box.

In some implementations, the target box determining module may further include:
an aesthetic scoring unit configured to input, based on a single throughput of an aesthetic scoring model, the plurality of first feature maps respectively corresponding to the plurality of first candidate boxes into the aesthetic scoring model in batches after the plurality of first candidate boxes are generated, such that the aesthetic scoring model outputs the aesthetic score of each first feature map.

In some implementations, the target box determining module may further include:
a pre-processing unit configured to resize the first feature maps corresponding to the first candidate boxes to a preset size before the first feature maps respectively corresponding to the plurality of first candidate boxes are input into the aesthetic scoring model in batches.

The image cropping apparatus provided in this embodiment of the present disclosure can perform the image cropping method provided in any one of the embodiments of the present disclosure, and has corresponding functional modules and effects for performing the method.

The plurality of units and modules included in the above apparatus are obtained through division merely according to functional logic, but are not limited to the above division, as long as corresponding functions can be implemented. In addition, the names of the plurality of functional units are merely used for mutual distinguishing, and are not intended to limit the protection scope of the embodiments of the present disclosure.

### Embodiment 6

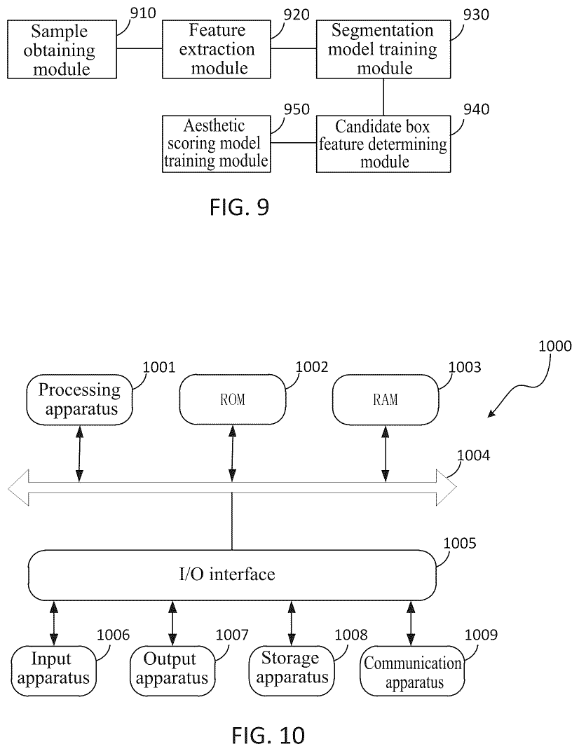

FIG. 9 is a schematic diagram of a structure of a model training apparatus according to Embodiment 6 of the present disclosure. The model training apparatus provided in this embodiment is applicable to training an image cropping model including a segmentation model and an aesthetic scoring model.

As shown in FIG. 9, the model training apparatus provided in this embodiment may include:
a sample obtaining module 910 configured to obtain a first sample image, a segmentation label of the first sample image, and an aesthetic score label corresponding to a sample cropping box of the first sample image; a feature extraction module 920 configured to perform feature extraction on the first sample image to obtain a third feature map; a segmentation model training module 930 configured to perform feature reconstruction on the third feature map using a segmentation model, to obtain a second segmented image, and train the segmentation model based on the second segmented image and the segmentation label; a candidate box feature determining module 940 configured to generate a second candidate box within the first sample image, and determine a fourth feature map corresponding to the second candidate box based on the third feature map and the second candidate box; and an aesthetic scoring model training module 950 configured to output a predicted score of the fourth feature map using an aesthetic scoring model, and train the aesthetic scoring model based on the predicted score and the aesthetic score label, where the trained segmentation model is used for determining the first segmented image in any of the image cropping methods of the embodiments of the present disclosure; and the trained aesthetic scoring model is used for determining the aesthetic score in any of the image cropping methods of the embodiments of the present disclosure.

In some implementations, if the first sample image and the aesthetic score label belong to an aesthetic evaluation data set, the segmentation label is obtained by segmenting the first sample image based on a preset model. Accordingly, the segmentation model training module may be further configured to:
obtain a second sample image when the segmentation model and the aesthetic scoring model are trained, and label the second sample image with a segmentation label; and fix parameters of the aesthetic scoring model, determine a third segmented image of the second sample image using the trained segmentation model, and optimize the segmentation model based on the third segmented image and the segmentation label of the second sample image.

The model training apparatus provided in this embodiment of the present disclosure can perform the model training method provided in any one of the embodiments of the present disclosure, and has corresponding functional modules and effects for performing the method.

The plurality of units and modules included in the above apparatus are obtained through division merely according to functional logic, but are not limited to the above division, as long as corresponding functions can be implemented. In addition, the names of the plurality of functional units are merely used for mutual distinguishing, and are not intended to limit the protection scope of the embodiments of the present disclosure.

### Embodiment 7

Reference is made to FIG. 10 below, which is a schematic diagram of a structure of an electronic device (such as a terminal device or a server in FIG. 10) 1000 suitable for implementing an embodiment of the present disclosure. The terminal device in this embodiment of the present disclosure may include, but is not limited to, a mobile terminal such as a mobile phone, a notebook computer, a digital broadcast receiver, a personal digital assistant (PDA), a portable android device (PAD), a portable media player (PMP), and a vehicle-mounted terminal (such as a vehicle navigation terminal), and a fixed terminal such as a television (TV) and a desktop computer. The electronic device 1000 shown in FIG. 10 is merely an example, and shall not impose any limitation on the function and scope of use of the embodiments of the present disclosure.

As shown in FIG. 10, the electronic device 1000 may include a processing apparatus (e.g., a central processor, a graphics processor) 1001 that may perform a variety of appropriate actions and processing in accordance with a program stored in a read-only memory (ROM) 1002 or a program loaded from a storage apparatus 1008 into a random access memory (RAM) 1003. The RAM 1003 further stores various programs and data required for the operation of the electronic device 1000. The processing apparatus 1001, the ROM 1002, and the RAM 1003 are connected to each other through a bus 1004. An input/output (I/O) interface 1005 is also connected to the bus 1004.

Generally, the following apparatuses may be connected to the I/O interface 1005: an input apparatus 1006 including, for example, a touch screen, a touchpad, a keyboard, a mouse, a camera, a microphone, an accelerometer, a gyroscope, etc.; an output apparatus 1007 including, for example, a liquid crystal display (LCD), a speaker, a vibrator, etc.; a storage apparatus 1008 including, for example, a tape, a hard disk, etc.; and a communication apparatus 1009. The communication apparatus 1009 may allow the electronic device 1000 to perform wireless or wired communication with other devices to exchange data. Although FIG. 10 shows the electronic device 1000 having various apparatuses, it is not required to implement or have all of the shown apparatuses. It may be an alternative to implement or have more or fewer apparatuses.

According to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the methods shown in the flowcharts. In such an embodiment, the computer program may be downloaded and installed from a network through the communication apparatus 1009, or installed from the storage apparatus 1008, or installed from the ROM 1002. When the computer program is executed by the processing apparatus 1001, the above-mentioned functions defined in the image cropping methods or the model training method according to the embodiments of the present disclosure are performed.

The electronic device provided in this embodiment of the present disclosure and the image cropping methods or the model training method provided in the above embodiments belong to the same concept. For the technical details not described in detail in this embodiment, reference can be made to the above embodiment, and this embodiment and the above embodiments have the same effects.

### Embodiment 8

This embodiment of the present disclosure provides a computer storage medium having stored thereon a computer program that, when executed by a processor, causes the image cropping methods or the model training method provided in the above embodiments to be implemented.

The above computer-readable medium described in the present disclosure may be a computer-readable signal medium, or a computer-readable storage medium, or any combination thereof. The computer-readable storage medium may be, for example, but is not limited to, electric, magnetic, optical, electromagnetic, infrared, or semi-conductive apparatuses or devices, or any combination thereof. Examples of the computer-readable storage medium may include, but are not limited to: an electrical connection having one or more wires, a portable computer magnetic disk, a hard disk, a RAM, a ROM, an erasable programmable read-only memory (EPROM) or a flash memory (FLASH), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution apparatus or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution apparatus or device. The program code contained in the computer-readable medium may be transmitted by any suitable medium, including but not limited to: electric wires, optical cables, radio frequency (RF), etc., or any suitable combination thereof.

In some implementations, a client and a server can communicate using any currently known or future-developed network protocol such as a HyperText Transfer Protocol (HTTP), and may be connected to digital data communication (for example, communication network) in any form or medium. Examples of the communication network include a local area network (LAN), a wide area network (WAN), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to:
segment an image to be cropped to obtain a first segmented image, and determine a bounding box of a target object in the image to be cropped based on the first segmented image; generate a plurality of first candidate boxes within the bounding box, and select a first target box from the plurality of first candidate boxes based on an aesthetic score of a first feature map corresponding to each first candidate box; and use an image located within the first target box in the image to be cropped as a cropping result.

Alternatively, the above computer-readable medium carries one or more programs that, when executed by the electronic device, cause the electronic device to:
obtain a first sample image, a segmentation label of the first sample image, and an aesthetic score label corresponding to a sample cropping box of the first sample image; perform feature extraction on the first sample image to obtain a third feature map; perform feature reconstruction on the third feature map using a segmentation model, to obtain a second segmented image, and train the segmentation model based on the second segmented image and the segmentation label; generate a second candidate box within the first sample image, and determine a fourth feature map corresponding to the second candidate box based on the third feature map and the second candidate box; and output a predicted score of the fourth feature map using an aesthetic scoring model, and train the aesthetic scoring model based on the predicted score and the aesthetic score label, where the trained segmentation model is used for determining the first segmented image in any of the image cropping methods of the embodiments of the present disclosure; and the trained aesthetic scoring model is used for determining the aesthetic score in any of the image cropping methods of the embodiments of the present disclosure.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including LAN or WAN, or may be connected to an external computer (for example, connected over the Internet using an Internet service provider).

The flowcharts and the block diagrams in the accompanying drawings illustrate the possibly implemented architecture, functions, and operations of the methods and computer program product according to various embodiments of the present disclosure. In this regard, each block in the flowcharts or the block diagrams may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagrams and/or the flowcharts, and a combination of the blocks in the block diagrams and/or the flowcharts may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. The names of the units and the modules do not constitute a limitation on the units and the modules themselves in one case.

The functions described herein above may be performed at least partially by one or more hardware logic components. For example, without limitation, exemplary types of hardware logic components that may be used include: a field programmable gate array (FPGA), an application-specific integrated circuit (ASIC), application-specific standard parts (ASSP), a system-on-chip (SOC) system, a complex programming logic device (CPLD), and the like.

In the context of the present disclosure, a machine-readable medium may be a tangible medium that may contain or store a program used by or in combination with an instruction execution apparatus or device. The machine-readable medium may be a machine-readable signal medium or a machine-readable storage medium. The machine-readable medium may include, but is not limited to, electronic, magnetic, optical, electromagnetic, infrared, or semiconductor apparatuses or devices, or any suitable combination thereof. Examples of the machine-readable storage medium may include an electrical connection based on one or more wires, a portable computer disk, a hard disk, a RAM, a ROM, an EPROM or a flash memory, an optical fiber, a CD-ROM, an optical storage device, a magnetic storage device, or any suitable combination thereof.

According to one or more embodiments of the present disclosure, [Example 1] provides an image cropping method, and the method includes:
segmenting an image to be cropped to obtain a first segmented image, and determining a bounding box of a target object in the image to be cropped based on the first segmented image;
generating a plurality of first candidate boxes within the bounding box, and selecting a first target box from the plurality of first candidate boxes based on an aesthetic score of a first feature map corresponding to each first candidate box; and
using an image located within the first target box in the image to be cropped as a cropping result.

According to one or more embodiments of the present disclosure, [Example 2] provides an image cropping method, and the method further includes the following step.

In some implementations, the segmenting an image to be cropped to obtain a first segmented image includes:
performing feature extraction on the image to be cropped to obtain a second feature map, and performing feature reconstruction on the second feature map using a segmentation model, to obtain the first segmented image.

Accordingly, the first feature map is determined based on the second feature map and the first candidate boxes.

According to one or more embodiments of the present disclosure, [Example 3] provides an image cropping method, and the method further includes the following step.

In some implementations, the determining a bounding box of a target object in the image to be cropped based on the first segmented image includes:
determining the bounding box of the target object in the image to be cropped based on position coordinates of pixels in the first segmented image that belong to a semantic class of the target object.

According to one or more embodiments of the present disclosure, [Example 4] provides an image cropping method, and the method further includes the following step.

In some implementations, the generating a plurality of first candidate boxes within the bounding box includes:
generating, based on an input crop ratio, first candidate boxes conforming to the crop ratio within the bounding box; and/or
generating, based on an input cropping precision, a number of first candidate boxes corresponding to the cropping precision within the bounding box.

According to one or more embodiments of the present disclosure, [Example 5] provides an image cropping method and a model training method, and the methods further include the following step.

In some implementations, after the generating a plurality of first candidate boxes, the method further includes:
inputting, based on a single throughput of an aesthetic scoring model, the plurality of first feature maps respectively corresponding to the plurality of first candidate boxes into the aesthetic scoring model in batches, such that the aesthetic scoring model outputs the aesthetic score of each first feature map.

According to one or more embodiments of the present disclosure, [Example 6] provides an image cropping method and a model training method, and the methods further include the following step.

In some implementations, before the inputting the plurality of first feature maps respectively corresponding to the plurality of first candidate boxes into the aesthetic scoring model in batches, the method further includes:
resizing the first feature maps corresponding to the first candidate boxes to a preset size.

According to one or more embodiments of the present disclosure, [Example 7] provides a model training method, and the method includes:
obtaining a first sample image, a segmentation label of the first sample image, and an aesthetic score label corresponding to a sample cropping box of the first sample image;
performing feature extraction on the first sample image to obtain a third feature map;
performing feature reconstruction on the third feature map using a segmentation model, to obtain a second segmented image, and training the segmentation model based on the second segmented image and the segmentation label;
generating a second candidate box within the first sample image, and determining a fourth feature map corresponding to the second candidate box based on the third feature map and the second candidate box; and
outputting a predicted score of the fourth feature map using an aesthetic scoring model, and training the aesthetic scoring model based on the predicted score and the aesthetic score label, where
the trained segmentation model is used for determining the first segmented image described in the image cropping method according to any one of claims 1 to 6; and the trained aesthetic scoring model is used for determining the aesthetic score described in the image cropping method according to any one of claims 1 to 6.

According to one or more embodiments of the present disclosure, [Example 8] provides a model training method, and the method further includes the following step.

In some implementations, if the first sample image and the aesthetic score label belong to an aesthetic evaluation data set, the segmentation label is obtained by segmenting the first sample image based on a preset model.

Accordingly, when the segmentation model and the aesthetic scoring model are trained, the method further includes:
obtaining a second sample image, and labeling the second sample image with a segmentation label; and
fixing parameters of the aesthetic scoring model, determining a third segmented image of the second sample image using the trained segmentation model, and optimizing the segmentation model based on the third segmented image and the segmentation label of the second sample image.

Furthermore, although the various operations are depicted in a specific order, it should not be construed as requiring these operations to be performed in the specific order shown or in a sequential order. Under certain circumstances, multitasking and parallel processing may be advantageous. Similarly, although various implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

What is claimed is:

1. An image cropping method, comprising:
segmenting an image to be cropped to obtain a first segmented image, and determining a bounding box of a target object in the image to be cropped based on the first segmented image;
generating a plurality of first candidate boxes within the bounding box, and selecting a first target box from the plurality of first candidate boxes based on a score of a first feature map corresponding to each first candidate box; and
using an image located within the first target box in the image to be cropped as a cropping result.

2. The method according to claim 1, wherein the segmenting an image to be cropped to obtain a first segmented image comprises:
performing feature extraction on the image to be cropped to obtain a second feature map, and performing feature reconstruction on the second feature map using a segmentation model, to obtain the first segmented image; and
before the selecting a first target box from the first candidate boxes based on a score of a first feature map corresponding to the first candidate box, the method further comprises:
determining the first feature map based on the second feature map and the first candidate boxes.

3. The method according to claim 1, wherein the determining a bounding box of a target object in the image to be cropped based on the first segmented image comprises:
determining the bounding box of the target object in the image to be cropped based on position coordinates of pixels in the first segmented image that belong to a semantic class of the target object.

4. The method according to claim 1, wherein the generating a plurality of first candidate boxes within the bounding box comprises at least one of:
generating, based on an input crop ratio, a plurality of first candidate boxes conforming to the crop ratio within the bounding box; and
generating, based on an input cropping precision, a number of first candidate boxes corresponding to the cropping precision within the bounding box.

5. The method according to claim 1, wherein after the generating a plurality of first candidate boxes, the method further comprises:
inputting, based on a single throughput of a scoring model, the plurality of first feature maps respectively corresponding to the plurality of first candidate boxes into the scoring model in batches, such that the scoring model outputs the score of each first feature map.

6. The method according to claim 5, wherein before the inputting the plurality of first feature maps respectively corresponding to the plurality of first candidate boxes into the scoring model in batches, the method further comprises:
resizing the first feature maps corresponding to the first candidate boxes to a preset size.

7. A model training method, comprising:
obtaining a first sample image, a segmentation label of the first sample image, and a score label corresponding to a sample cropping box of the first sample image;
performing feature extraction on the first sample image to obtain a third feature map;
performing feature reconstruction on the third feature map using a segmentation model, to obtain a second segmented image, and training the segmentation model based on the second segmented image and the segmentation label;
generating a second candidate box within the first sample image, and determining a fourth feature map corresponding to the second candidate box based on the third feature map and the second candidate box; and
outputting a predicted score of the fourth feature map using a scoring model, and training the scoring model based on the predicted score and the score label, wherein
the trained segmentation model is used for determining the first segmented image described in the image cropping method according to claim 1; and the trained scoring model is used for determining the score described in the image cropping method according to claim 1.

8. The method according to claim 7, wherein when the first sample image and the score label belong to an evaluation data set, the segmentation label is obtained by segmenting the first sample image based on a preset model; and
when the segmentation model and the scoring model are trained, the method further comprises:
obtaining a second sample image, and labeling the second sample image with a segmentation label; and
fixing parameters of the scoring model, determining a third segmented image of the second sample image using the trained segmentation model, and optimizing the segmentation model based on the third segmented image and the segmentation label of the second sample image.

9. (canceled)

10. (canceled)

11. An electronic device, comprising:
at least one processor; and
a storage apparatus configured to store at least one program, wherein
the at least one program, when executed by the at least one processor, causes the at least one processor to:
segment an image to be cropped to obtain a first segmented image, and determine a bounding box of a target object in the image to be cropped based on the first segmented image;
generate a plurality of first candidate boxes within the bounding box, and select a first target box from the plurality of first candidate boxes based on a score of a first feature map corresponding to each first candidate box; and
use an image located within the first target box in the image to be cropped as a cropping result.

12. A non-transitory storage medium comprising computer-executable instructions, wherein the computer-executable instructions, when executed by a computer processor, are used to perform:
segmenting an image to be cropped to obtain a first segmented image, and determining a bounding box of a target object in the image to be cropped based on the first segmented image;
generating a plurality of first candidate boxes within the bounding box, and selecting a first target box from the plurality of first candidate boxes based on a score of a first feature map corresponding to each first candidate box; and
using an image located within the first target box in the image to be cropped as a cropping result.

13. The electronic device according to claim 11, wherein the at least one processor is caused to segment an image to be cropped to obtain a first segmented image comprises being caused to:
perform feature extraction on the image to be cropped to obtain a second feature map, and perform feature reconstruction on the second feature map using a segmentation model, to obtain the first segmented image; and
before the selecting a first target box from the first candidate boxes based on a score of a first feature map corresponding to the first candidate box, determine the first feature map based on the second feature map and the first candidate boxes.

14. The electronic device according to claim 11, wherein the at least one processor is caused to determine a bounding box of a target object in the image to be cropped based on the first segmented image comprises being caused to:
determine the bounding box of the target object in the image to be cropped based on position coordinates of pixels in the first segmented image that belong to a semantic class of the target object.

15. The electronic device according to claim 11, wherein the at least one processor is caused to generate a plurality of first candidate boxes within the bounding box comprises at least one of being caused to:
generate, based on an input crop ratio, a plurality of first candidate boxes conforming to the crop ratio within the bounding box; and
generate, based on an input cropping precision, a number of first candidate boxes corresponding to the cropping precision within the bounding box.

16. The electronic device according to claim 11, wherein the at least one processor is further caused to after the generating a plurality of first candidate boxes:
input, based on a single throughput of a scoring model, the plurality of first feature maps respectively corresponding to the plurality of first candidate boxes into the scoring model in batches, such that the scoring model outputs the score of each first feature map.

17. The electronic device according to claim 16, wherein the at least one processor is caused to before the inputting the plurality of first feature maps respectively corresponding to the plurality of first candidate boxes into the scoring model in batches:
resize the first feature maps corresponding to the first candidate boxes to a preset size.

18. An electronic device, comprising:
at least one processor; and
a storage apparatus configured to store at least one program, wherein
the at least one program, when executed by the at least one processor, causes the at least one processor to:
obtain a first sample image, a segmentation label of the first sample image, and a score label corresponding to a sample cropping box of the first sample image;
perform feature extraction on the first sample image to obtain a third feature map;
perform feature reconstruction on the third feature map using a segmentation model, to obtain a second segmented image, and train the segmentation model based on the second segmented image and the segmentation label;
generate a second candidate box within the first sample image, and determine a fourth feature map corresponding to the second candidate box based on the third feature map and the second candidate box; and
output a predicted score of the fourth feature map using a scoring model, and train the scoring model based on the predicted score and the score label, wherein
the trained segmentation model is used for determining the first segmented image described in the electronic device according to claim 11; and the trained scoring model is used for determining the score described in the electronic device according to claim 11.

19. The electronic device according to claim 18, wherein when the first sample image and the score label belong to an evaluation data set, the segmentation label is obtained by segmenting the first sample image based on a preset model; and
when the segmentation model and the scoring model are trained, the at least one processor is further caused to:
obtain a second sample image, and label the second sample image with a segmentation label; and
fix parameters of the scoring model, determine a third segmented image of the second sample image using the trained segmentation model, and optimize the segmentation model based on the third segmented image and the segmentation label of the second sample image.

20. The non-transitory storage medium according to claim 12, wherein the segmenting an image to be cropped to obtain a first segmented image comprises:
performing feature extraction on the image to be cropped to obtain a second feature map, and performing feature reconstruction on the second feature map using a segmentation model, to obtain the first segmented image; and
before the selecting a first target box from the first candidate boxes based on a score of a first feature map corresponding to the first candidate box, the method further comprises:
determining the first feature map based on the second feature map and the first candidate boxes.

21. The non-transitory storage medium according to claim 12, wherein the determining a bounding box of a target object in the image to be cropped based on the first segmented image comprises:
determining the bounding box of the target object in the image to be cropped based on position coordinates of pixels in the first segmented image that belong to a semantic class of the target object.

22. The non-transitory storage medium according to claim 12, wherein the generating a plurality of first candidate boxes within the bounding box comprises at least one of:
generating, based on an input crop ratio, a plurality of first candidate boxes conforming to the crop ratio within the bounding box; and
generating, based on an input cropping precision, a number of first candidate boxes corresponding to the cropping precision within the bounding box.
